(19) United States
(12) Patent Application Publication
(10) Pub. No.: US 2018/0147713 A1
(43) Pub. Date: May 31, 2018

(54) HYBRID POWER TOOLS

(71) Applicant: Ridge Tool Company, Elyria, OH (US)

(72) Inventors: Christopher Schmauder, Olmsted Falls, OH (US); Jon R. Dunkin, Elyria, OH (US); David Troike, South Amherst, OH (US)

(21) Appl. No.: 15/826,822

(22) Filed: Nov. 30, 2017

Related U.S. Application Data
(60) Provisional application No. 62/428,043, filed on Nov. 30, 2016.

(51) Int. Cl. B25F 5/02; B23D 45/16; B23G 1/24; E03C 1/302

(52) U.S. Cl. CPC B25F 5/02; B23D 45/16; H02K 7/14; E03C 1/302; B23G 1/24

(57) ABSTRACT

Electrical devices such as tools or tool systems are described which receive electrical power from either a separable battery or an electrical power cord. In certain versions, the tools include both a power cord receptacle and a battery receiving region located along the exterior of the tool housing. The tools can be configured such that when a battery is powering the tool, connection of a power cord to the tool is precluded. The tools can also be configured so that when a power cord is connected to the tool, connection of a battery is precluded. In particular, a hybrid drain cleaning tool system is also described that includes a hybrid drain cleaning tool in combination with a separable battery. Also described are hybrid powered threader devices and hybrid powered saw devices.

### CROSS REFERENCES TO RELATED APPLICATIONS

This application claims priority upon U.S. provisional application Ser. No. 62/428,043 filed Nov. 30, 2016.

### FIELD

The present subject matter relates to tools that can operate using electrical power from different sources. In particular, the present subject matter relates to drain cleaning tools that are powered from AC or DC power sources, using power cords or cables, and/or batteries.

### BACKGROUND

Electrically powered tools are known that can be powered from a detachable battery which in many instances is rechargeable, or powered using a separate electrical power converter which is typically connected to an electrical outlet using a power cord and/or a conventional extension cord. In some instances, the converter may be configured to connect to the tool as would a battery. And so, such converters have been shaped to match the shape of a corresponding battery at least within the portion of the converter that engages the tool. When using a battery power source, the tool may convert the direct current (DC) from the battery to alternating current (AC) if the tool utilizes an AC electric motor. Alternatively, when using a converter connected to an AC electrical outlet, the converter converts the AC power to DC power if desirable for the motor and/or other components of the tool. Examples of such systems are described in the prior art such as U.S. Pat. No. 4,835,410 and U.S. Pat. No. 6,675,912.

Although satisfactory in many respects, such tools have not found widespread acceptance in industry or by home owners. One possible reason for this is that when using multiple tools, each having its own battery and/or battery type, battery mix up can occur particularly when a battery is detached from its tool such as during recharging. Similarly, when a corded converter is detached from the tool, mix up can occur between converters. If the power cord is detachable from the converter, this further promotes potential for loss or mix up between batteries, converters, and/or power cords. Another reason why such tools have not found widespread acceptance is that external, separate power converters frequently become lost, misplaced, or used in other applications. This severely limits use of the tool as the tool can only be operated using its battery.

Recognizing these and other problems, tool systems have been devised with detachable battery packs having on-board converters and power cords connected to the battery pack. The battery pack can be engaged with the tool and used to power the tool. Or the power cord can be connected to an external power source which then powers the tool while the battery pack remains engaged with the tool. Examples of such systems are described in U.S. 2007/0279000. Although satisfactory, such systems can be unnecessarily bulky and heavy when powering the tool from an external power source since the battery pack must remain engaged with the tool. In addition, if any of the battery, the battery circuitry, the converter, or the power cord circuitry fails, the entire assembly must be replaced. Accordingly, a need exists for a new configuration for powering a tool.

Thus, although various configurations are known for powering electrical tools and tool systems, the known configurations have drawbacks. In addition, for tools or tool systems having provisions for receiving power from either a corded connection or from a battery; when powering the tool using the battery, the corded connection(s) may be exposed to entry or contamination from moisture, dirt, or other debris. This potential problem may be significant if the tool is used at a jobsite or outside. Accordingly, a need remains for a new configuration and strategy for supplying power to electric tools and/or tool systems which avoids these drawbacks.

One type of tool system which is frequently used in wet or dirty environments are drain cleaning tools. Drain cleaning tools having extendable flexible drain cleaning cables or “snakes” are well known in the art. Electrically powered drain cleaners typically include an electric motor and a power cord for connection to an electrical power source. Alternatively, battery powered drain cleaners are also known. Electrically powered drain cleaners typically have relatively high power demands and so previous power configurations for such devices have been limited. As noted, such devices are typically used in environments filled with water, dirt, and debris. And so previous power configurations emphasized reliability over convenience or flexibility. Accordingly, a need remains for an improved powered drain cleaning tool that can readily operate using electrical power from different sources.

### SUMMARY

The difficulties and drawbacks associated with previous approaches are addressed in the present subject matter as follows.

In one aspect, the present subject matter provides an electrically powered device comprising a housing defining an internal hollow region, and an electrical power converter having an input and an output. The converter is configured to receive an alternating electrical current at the input and produce a direct electrical current at the output. The converter is disposed and mounted within the internal region of the housing. The device also comprises an electric motor disposed and mounted within the internal region of the housing. The electric motor is in electrical communication with the output of the converter. The device also comprises a power cord receptacle accessible for engagement with a power cord along an exterior of the housing. The power cord receptacle is in electrical communication with the input of the converter. And, the device comprises a battery receiving region accessible along an exterior of the housing. The battery receiving region includes provisions to releasably engage a battery to the device.

In another aspect, the present subject matter also provides an electrically powered device comprising, a housing defining an internal hollow region, and an electric motor disposed and mounted within the internal region of the housing. The device also comprises a power cord receptacle selectively accessible for engagement with a power cord along an exterior of the housing. The device also comprises a battery receiving region accessible along an exterior of the housing. The battery receiving region includes provisions to releasably engage a battery to the device. Upon placement of a battery in the battery receiving region and engagement of the battery to the device, access to the power cord receptacle from the exterior of the device is precluded.

In still another aspect, the present subject matter provides a drain cleaning device comprising a housing defining an internal hollow region, a rotatable drum, and an electric motor disposed and mounted within the internal region of the housing. Upon actuation of the electric motor, the rotatable drum is rotated. The device also comprises a rotatable drain cleaning cable, at least partially disposed in the drum. The device further comprises provisions for extending and retracting the drain cleaning cable relative to the device. The device also comprises a power cord receptacle selectively accessible for engagement with a power cord along an exterior of the housing. The device additionally comprises a battery receiving region accessible along an exterior of the housing. The battery receiving region includes provisions to releasably engage a battery to the device. Upon placement of a battery in the battery receiving region and engagement of the battery to the device, access to the power cord receptacle from the exterior of the device is precluded.

In yet another aspect, the present subject matter provides a powered threader device comprising a housing defining an internal hollow region. The threader device also comprises a rotatable drive for rotating a thread cutting assembly. The threader device additionally comprises an electric motor disposed and mounted within the internal region of the housing. Upon actuation of the electric motor, the thread cutting assembly is rotated. The threader device also comprises a power cord receptacle selectively accessible for engagement with a power cord along an exterior of the housing. The threader device additionally comprises a battery receiving region accessible along an exterior of the housing. The battery receiving region includes provisions to releasably engage a battery to the device. Upon placement of a battery in the battery receiving region and engagement of the battery to the device, access to the power cord receptacle from the exterior of the device is precluded.

In still another aspect, the present subject matter provides a powered saw device comprising a housing defining an internal hollow region. The saw also comprises a rotatable drive for displacing a cutting blade. The saw additionally comprises an electric motor disposed and mounted within the internal region of the housing, wherein upon actuation of the electric motor, the cutting blade is displaced. The saw also comprises a power cord receptacle selectively accessible for engagement with a power cord along an exterior of the housing. And, the saw also comprises a battery receiving region accessible along an exterior of the housing. The battery receiving region includes provisions to releasably engage a battery to the device. Upon placement of a battery in the battery receiving region and engagement of the battery to the device, access to the power cord receptacle from the exterior of the device is precluded.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic view illustrating an embodiment of a power receiving assembly utilized in a hybrid power tool in accordance with the present subject matter.

FIG. 2 is a schematic view illustrating the power receiving assembly of FIG. 1 in combination with a battery engaged therewith.

FIG. 3 shows an embodiment of a hybrid power drain cleaner in accordance with the present subject matter.

FIG. 4 shows the drain cleaner of FIG. 3 powered by a separable battery pack.

FIG. 5 shows the drain cleaner of FIG. 3 powered by an electrical power cord.

FIG. 6 is a schematic diagram illustrating power circuitry of the drain cleaner of FIGS. 3-5.

FIG. 7 is a schematic side elevational view of another embodiment of a hybrid power drain cleaner in accordance with the present subject matter.

FIG. 8 is a schematic rear perspective view of another embodiment of a hybrid drain cleaner in accordance with the present subject matter.

FIGS. 9-11 are schematic views of additional embodiments of a hybrid power drain cleaner illustrating various configurations for incorporating an electronics assembly and a battery with the drain cleaner.

FIGS. 12 and 13 are schematic views of a hybrid power drain cleaner illustrating two configurations for incorporating an electronics assembly and a battery with the drain cleaner.

FIGS. 14 and 15 are schematic views of the hybrid power drain cleaner of FIG. 12 in a corded configuration (FIG. 14) and in a battery configuration (FIG. 15).

FIGS. 16 and 17 are schematic views of the hybrid power drain cleaner of FIG. 13 in a corded configuration, although the cord shown is not connected to the drain cleaner (FIG. 16), and a battery configuration (FIG. 17).

FIG. 18 is a schematic side elevational view of another embodiment of a hybrid drain cleaner in accordance with the present subject matter.

FIG. 19 is a schematic side cross sectional view of the hybrid drain cleaner shown in FIG. 18, revealing an internal layout of the hybrid drain cleaner.

FIGS. 20-22 are schematic perspective views of housing components of he hybrid drain cleaner depicted in FIGS. 18 and 19.

FIG. 23 is a detailed schematic perspective view of the assembled housing components shown in FIGS. 21 and 22.

FIG. 24 is a partial rear perspective view of another embodiment of a hybrid drain cleaner in accordance with the present subject matter illustrating a configuration in which an electrical power receptacle is accessible along a rear region of the device.

FIG. 25 is a partial rear perspective view of the hybrid drain cleaner depicted in FIG. 24, illustrating a configuration in which the electrical power receptacle is not accessible due to engagement of a battery with the device.

FIG. 26 is a schematic diagram illustrating power circuitry of an embodiment of a hybrid drain cleaner in accordance with the present subject matter.

FIG. 27 illustrates another example of a hybrid power drain cleaner in accordance with the present subject matter.

FIG. 28 illustrates yet another example of a hybrid power drain cleaner in accordance with the present subject matter.

FIG. 29 illustrates an example of a hybrid power threader in accordance with the present subject matter.

FIG. 30 illustrates an example of a hybrid power saw in accordance with the present subject matter.

### DETAILED DESCRIPTION OF THE EMBODIMENTS

The present subject matter provides a wide array of hybrid power tools which avoid the requirement of an external or separate power converter. These hybrid power tools can be powered by directly connecting one end of a conventional electrical extension cord to the tool, and the other end of the extension cord into an AC electrical outlet. In particular versions of the hybrid power tools, the tools are free of any cord permanently attached to the tool, instead utilizing a power cord receptacle along an exterior region of the tool. However, it will be appreciated that in certain versions, the tools and/or tool systems may include a power cord attached to the tool in either a permanent or selectively releasable manner.

The present subject matter also provides hybrid power tools or tool systems that can be powered from one or more batteries or battery packs, or alternatively can be powered by connection to an electrical outlet such as a 120 volt AC power source outlet with a standard extension cord. In certain embodiments, the standard extension cord can be engaged directly with the tool such that no adapters or other components are needed. The AC power can be converted into DC power through a power switching circuit internal to the tool which transforms the AC power into DC power and in many instances also reduces the voltage. A DC battery can directly connect to the tool for battery or cord-free use. In many embodiments, the tools include provisions which preclude connection of the tool to an external power source when a battery is powering the tool. And, in many embodiments, the tools include provisions for storing or otherwise carrying the battery with the tool when the tool is not in use or when the tool is powered from an external power source.

The present subject matter also provides hybrid power drain cleaners that can be powered from one or more batteries or battery packs, or alternatively can be connected directly to an electrical outlet such as a 120 volt AC power source outlet with a standard extension cord. The 120 volt AC connection for example is converted into 18 volt DC power for example, through a power switching circuit within the drain cleaner which transforms the 120 volt AC power supply into 120 volt DC then reduces the voltage to 18 volt DC. An 18 volt DC battery can directly connect to the motor for battery or cord-free use. Throughout this description, it will be understood that the hybrid power tools and drain cleaners can accept AC power at a wide range of voltage levels, and greater than and/or less than 120 volts. For example, the tools and drain cleaners can accept AC power at 230 or 240 volts. Typically, a range of voltages can be accepted such as from 100 volts to 250 volts. The power converters in many embodiments reduce the voltage at the converter output to within a range of from 6 to 60 volts for example. In many versions of the drain cleaners, the drain cleaners include provisions that preclude connection of the tool to an external AC power source when a DC battery is powering the tool. And, in many embodiments, the drain cleaners include provisions for storing or otherwise carrying the battery with the cleaner when the drain cleaner is not in use or when powered from an external AC power source.

The systems incorporated in the tools and/or drain cleaners may also include an internal ground fault circuit interrupter (GFCI) for user protection and/or a current limiting device to protect the battery and/or power circuit from drawing an excessive level of electrical current. The systems incorporated in the tools and/or drain cleaners may also include a battery “shoe” adapter allowing a user to connect different battery platforms to the product independent of the product manufacturer. These aspects are described in greater detail herein.

The term “battery” or “battery pack” as used herein refers to an electric battery having one or more electrochemical cells which supply electric power through a positive terminal or cathode, and a negative terminal or anode. The terms include a single cell or multiple cells. The terms also include single-use or “disposable” batteries. In many embodiments, the terms include rechargeable batteries. The terms include a wide array of cell types including lead-acid and lithium-ion batteries. In many embodiments, the terms as used herein include a DC power source having a voltage within a range of from 6 volts to 48 volts, however, the terms as used herein include batteries having voltage outputs less than 6 volts and/or greater than 48 volts.

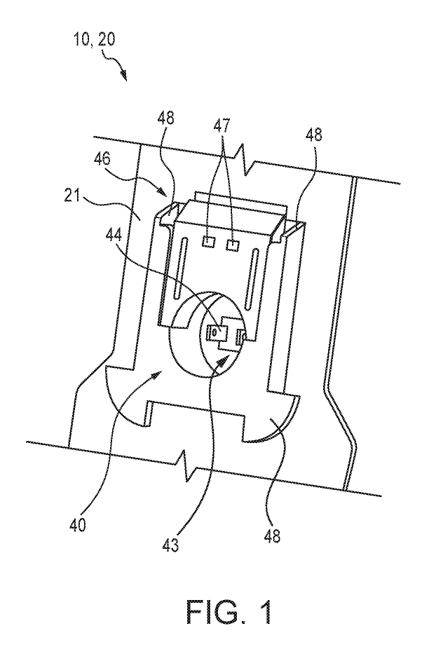

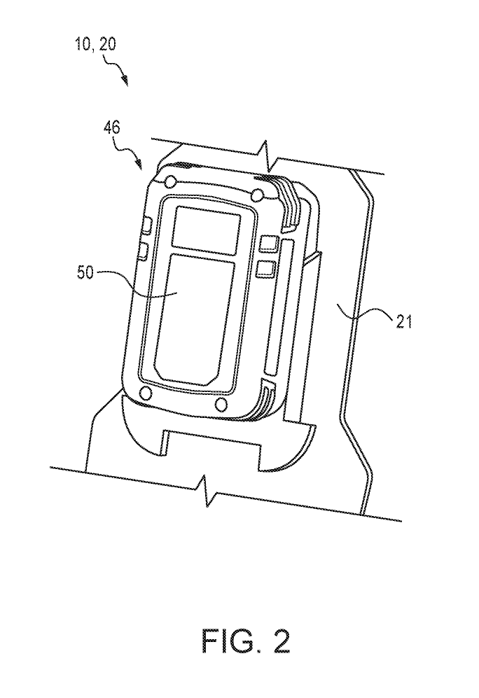

FIGS. 1-2 schematically illustrate a system 10 and/or tool 20 having a power receiving assembly in accordance with the present subject matter. These tools or systems are referred to herein as “hybrid power tools.” The system 10 is incorporated in a tool 20 which can be in the form of a variety of electrically powered tools as described in greater detail herein. The system 10 may additionally comprise one or more separable batteries 50 as shown in FIG. 2, which are configured to be placed in electrical power communication with the tool 20. The tool 20 can also be placed in electrical power communication with a conventional electric power cord (not shown in FIGS. 1-2).

The tool 20 can be provided in a variety of different forms and may be embodied in a wide array of different tool types. Various examples are provided herein. Typically, the tool 20 includes a housing 21 that generally encloses and supports an electric motor (not shown in FIGS. 1-2) and electronics and/or controls.

The tool 20 also includes a power receiving assembly that includes provisions for receiving electrical power from a separable battery 50 and/or a power cord. In the embodiment shown in FIGS. 1-2, the power receiving assembly includes an electric power receptacle 40 and a battery (or battery pack) receiving region 46.

The power receptacle 40 is provided along an exterior region of the housing 21 of the tool 20 and generally affixed thereto. The power receptacle 40 defines an external face along which electrical prongs 44 are accessible. In many versions, the power receptacle 40 is adjacent to and/or relatively close to the battery pack receiving region 46. In many versions, the face of the receptacle 40 is configured to define a recessed region 43 within which the prongs 44 are located. The depth of the region 43 is typically at least as great as the length of the prongs 44. This configuration enables the prongs 44 to be accessible when connecting the power cord thereto, yet not interfere when engaging the battery pack 50 with the battery pack receiving region 46. As will also be understood, the recessed region 43 is sized and shaped so as to accept a plug head of the power cord.

As previously noted, the electrical prongs 44 are typically provided so as to be readily connected with a standard 120 VAC connection and thus be in a conventional three-prong arrangement including “hot,” neutral, and ground prongs. In many versions, the prongs 44 are sized and shaped to engaged electrical receptors provided in the plug head of the power cord. However, as previously noted, it will be understood that the present subject matter includes electrical prongs 44 having two or three prongs in other arrangements generally denoted as Plug Types A-O as defined by the US Department of Commerce International Trade Administration (ITA).

The battery pack receiving region 46 can also be provided in a variety of different forms and arrangements. In many versions of the tool 20, one or ore engagement members 48 are provided which are sized, shaped, and/or arranged to engage a separable battery pack such as battery pack 50. The collection of members 48 can be in the form of a “shoe” adapter as known in the art which enables a battery pack 50 to be slidingly engaged with the battery receiving region 46 to retain the battery pack 50 with the tool 20 and also enable and maintain electrical connection between the region 46 and the battery pack 50. The battery receiving region 46 typically includes a latch assembly for selective coupling with the battery 50 and/or a track for selective sliding engagement with the battery 50. As will be appreciated, the battery receiving region 46 also includes one or more electrical connectors or terminals 47 which are placed into electrical communication with corresponding electrical connectors or terminals on the battery pack 50. In many embodiments, the power receptacle 40 and/or the battery receiving region 46 are configured so that if a power cord is connected to the receptacle 40, the battery pack 50 can not be connected to the region 46; and if the battery pack 50 is connected to the battery receiving region 46, the power cord can not be connected to the receptacle 40.

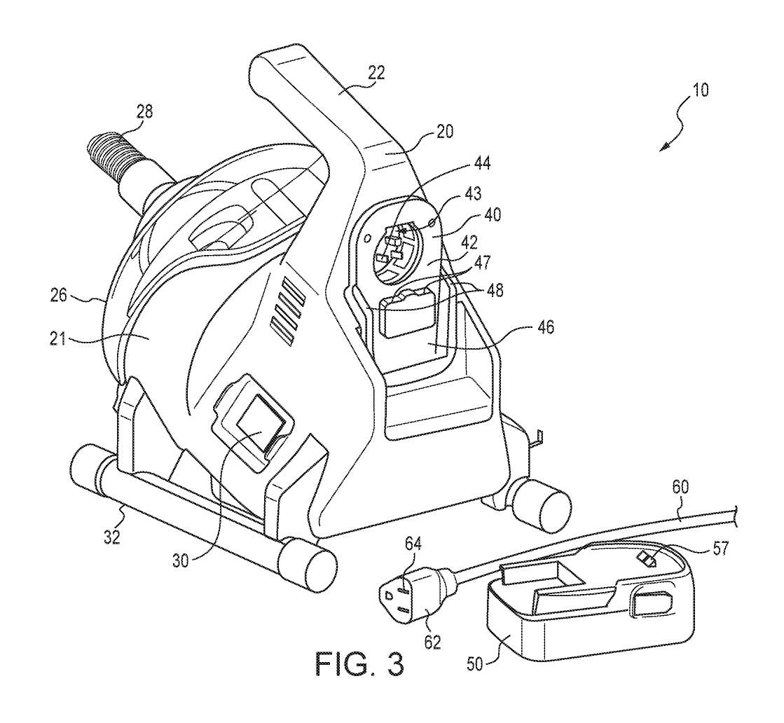

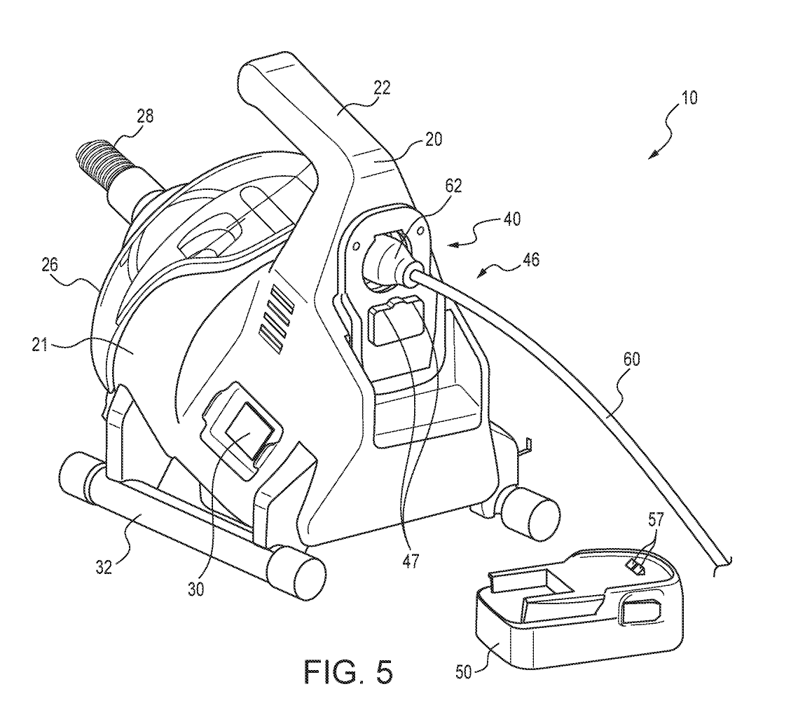

FIGS. 3-5 illustrate an example of a tool system which is a hybrid power drain cleaning tool system 10 in accordance with the present subject matter. The system 10 comprises a hybrid power drain cleaning tool 20 and one or more separable battery packs 50 which are configured to be placed in electrical power communication with the tool 20. The drain cleaning tool 20 can also be placed in electrical power communication with a conventional electrical power cord such as cord 60.

The drain cleaning tool 20 can be provided in a variety of different forms and arrangements. Typically, the tool 20 includes a housing 21 that generally encloses and/or supports an electrical motor (not shown) that drives, i.e., rotates, a flexible drain cleaning cable, and one or more operating controls such as control 30 which may include a power switch, and/or a forward/reverse control. FIG. 3 illustrates a guide hose 28 which typically at least partially houses the drain cleaning cable. The tool also includes provisions for extending and retracting the drain cleaning cable as known in the art. The housing may include a storage region for storing the drain cleaning cable. The tool 20 may optionally include a handle 22, one or more guards or shields 26, and/or a base 32.

The tool 20 also includes a power receiving assembly that includes provisions for receiving electrical power from the separable battery pack 50 and/or the power cord 60. In the version shown in the referenced figures, the power receiving assembly includes an electric power receptacle 40 and a battery (or battery pack) receiving region 46. The power receptacle 40 is provided along an exterior region of the housing 21 of the tool 20 and generally affixed thereto. The power receptacle 40 defines an external face 42 along which electrical prongs 44 are accessible. In many versions, the power receptacle 40 is adjacent to and/or relatively close to the battery pack receiving region 46. In many versions, the face 42 of the receptacle 40 is configured to define a recessed region 43 within which the prongs 44 are located. The depth of the region 43 is typically at least as great as the length of the prongs 44. This configuration enables the prongs 44 to be accessible when connecting the power cord 60 thereto, yet not interfere when engaging the battery pack 50 with the battery pack receiving region 46. As will also be understood, the recessed region 43 is sized and shaped so as to accept a plug head 62 of the power cord 60.

As previously noted, the electrical prongs 44 are typically provided so as to be readily connected with a standard 120 VAC connection and thus be in a conventional three-prong arrangement including “hot,” neutral, and ground prongs. In many versions, the prongs 44 are sized and shaped to engaged electrical receptors 64 provided in the plug head 62 of the power cord 60. However, as previously noted, it will be understood that the present subject matter includes electrical prongs 44 having two or three prongs in other arrangements generally denoted as Plug Types A-O as defined by the US Department of Commerce International Trade Administration (ITA). The power cord 60 is shown with a plug head 62 of Plug Type B which is common in the US.

The battery pack receiving region 46 can also be provided in a variety of different forms and arrangements. In many versions of the drain cleaning tool 10, one or more engagement members 48 are provided which are sized, shaped, and/or arranged to engage a separable battery pack such as battery pack 50. The collection of members 48 can be in the form of a “shoe” adapter as known in the art which enables a battery pack 50 to be slidingly engaged with the battery receiving region 46 to retain the battery pack 50 with the tool 20 and also enable and maintain electrical connection between the region 46 and the battery pack 50. The battery receiving region 46 typically includes a latch assembly for selective coupling with the battery 50 and/or a track for selective sliding engagement with the battery 50. As will be appreciated, the battery receiving region 46 also includes one or more electrical connectors or terminals 47 which are placed into electrical communication with corresponding electrical connectors or terminals 57 on the battery pack 50. In many embodiments, the power receptacle 40 and/or the battery receiving region 46 are configured so that if a power cord 60 is connected to the receptacle 40, the battery pack 50 can not be connected to the region 46; and if the battery pack 50 is connected to the battery receiving region 46, the power cord 60 can not be connected to the receptacle 40.

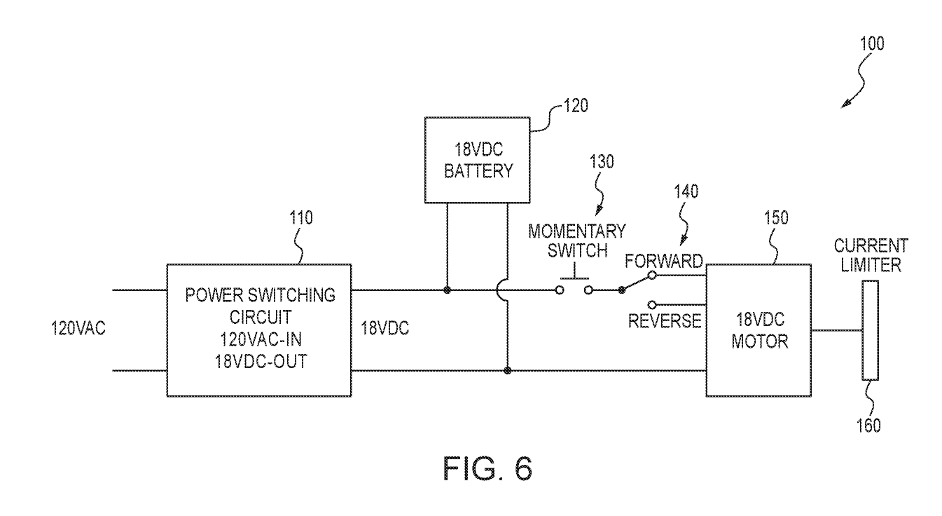

FIG. 6 schematically illustrates a representative circuit 100 utilized by a hybrid power drain cleaning tool system such as for example system 10, in accordance with the present subject matter. The circuit 100 includes one or more components 110 for converting an electrical power source such as a 120 VAC source to a lower voltage source and typically a lower voltage direct current such as 18 VDC. In many versions of the present subject matter, the at least one component 110 is configured to receive an electrical power source at a first voltage and provide or output an electrical current at a second voltage that is less than the first voltage, i.e., reducing the input voltage of 120 to 18 as shown in FIG. 6. The component 110 typically receives electrical power from a power receptacle such as previously described receptacle 40. In many versions of the present subject matter, the at least one component 110 is configured to transform the input power which is typically an AC source, to a DC source. It will be understood that the present subject matter includes the component(s) 110 configured to receive other voltage inputs such as 110 VAC, 120 VAC, 220 VAC, 230 VAC, 240 VAC and others, typically at 50 or 60 Hz; and transform or reduce such inputs to lower voltages such as 12 VDC, 24 VDC, 36 VDC, or others.

The circuit 100 depicted in FIG. 6 also depicts electrical connection of a battery pack 120 which can for example be in the form of an 18 VDC battery. The battery pack 120 can provide electric power at other voltages less than or greater than 18 volts. Typically, the battery pack 120 corresponds to a battery such as previously described battery 50 engaged and connected to the battery receiving region 46.

The circuit 100 may also include one or more switches such as a momentary switch 130. Typically, the circuit 100 also includes provisions 140 for controlling operation of an electrical motor 150 of the tool or system. The circuit 100 may additionally include one or more current limiters 160 to limit current flow in the circuit 100. Although FIG. 6 shows the circuit 100 for use with an 18 VDC battery pack and using an 18 VDC electric motor, as previously noted the system may employ circuit(s) and motor(s) operating at different voltages than 18 VDC. The circuit may also include a ground fault circuit interrupter (not shown). The circuit may also include one or more electromagnetic interference (EMI) filters.

In many versions of the present subject matter, the power switching circuit is configured to accommodate typical operating electrical power levels of at least 50 watts, in certain embodiments at least 100 watts, at least 250 watts, at least 500 watts, at least 1,000 watts, and in particular versions, at least 1,500 watts or greater. The power switching circuit can be configured to accommodate electrical power levels up to 2,000 watts, and in certain embodiments, up to 2,500 watts, 3,000 watts, 3,500 watts, 4,000 watts, and in particular embodiments, up to 5,000 watts or greater.

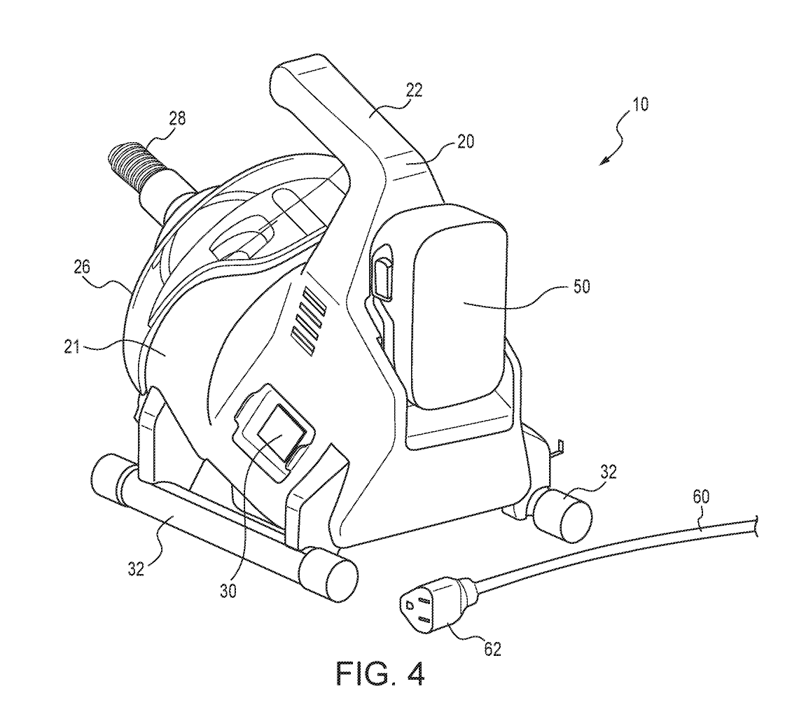

Instead of using a power switching circuit as depicted in FIG. 4, the present subject matter also includes utilizing a transformer with a rectifier. For example, a step-down transformer with rectifier could be used to convert 120 VAC or some other AC source, to 18 VDC or some other low voltage.

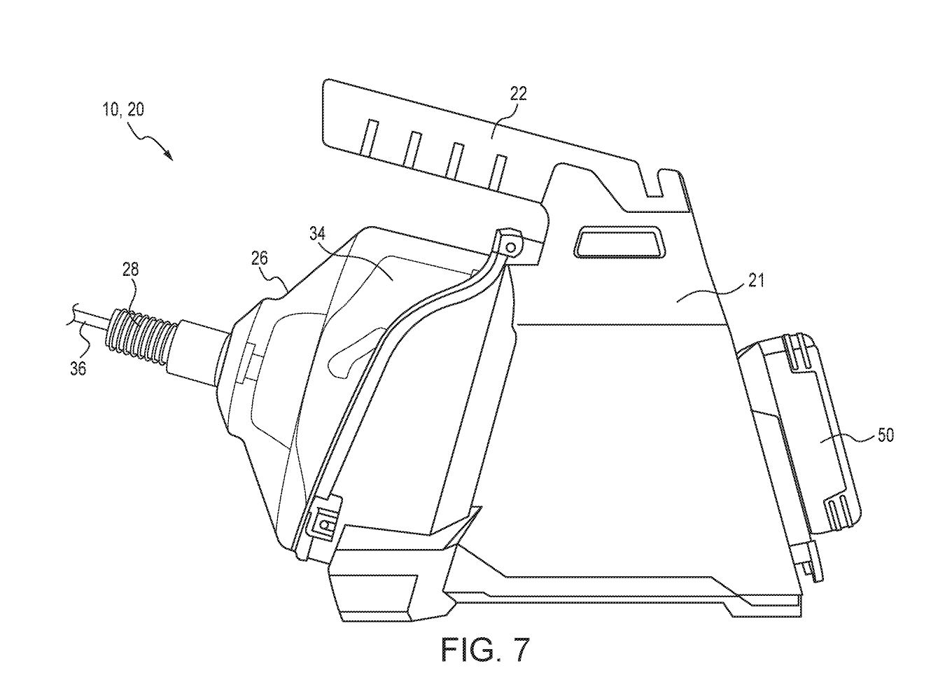

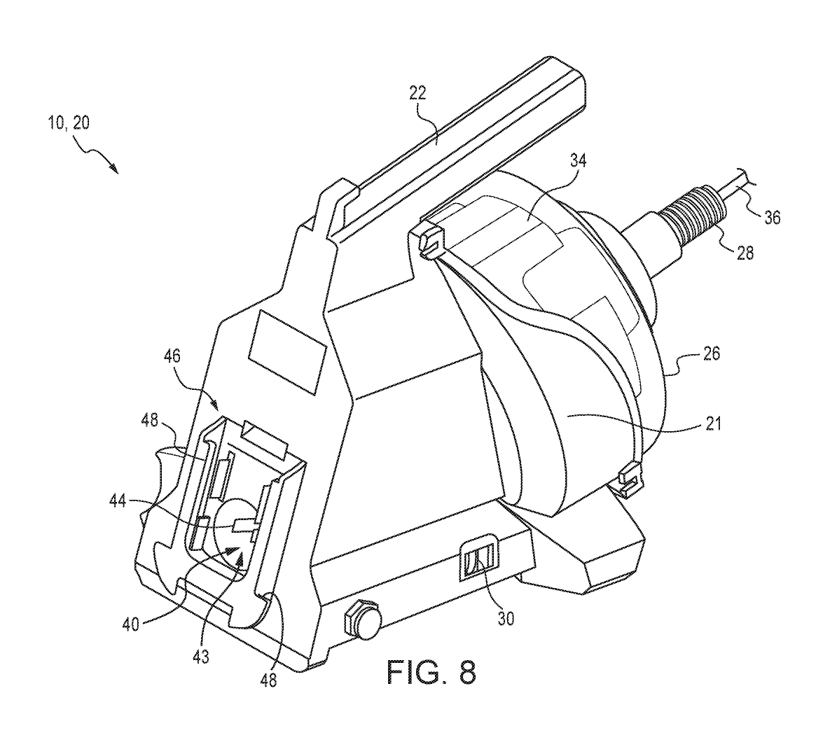

FIGS. 7 and 8 illustrate another embodiment of a tool system 10 and more particularly a hybrid power drain cleaner 20 in accordance with the present subject matter. The drain cleaning tool 20 comprises a housing 21 that defines one or more internal generally hollow regions (not shown), a handle 22, an electrical power converter (not shown) disposed and mounted within the internal region of the housing 21, a rotatable drum 34, an electric motor (not shown) disposed and mounted within the internal region of the housing 21, a power cord receptacle 40 accessible for engagement with a power cord (not shown) along an exterior of the housing 21 a battery receiving region 46 accessible along an exterior of the housing 21, a rotatable drain cleaning cable 36 which is typically at least partially disposed in the drum 34, and provisions (not shown) for extending and retracting the drain cleaning cable 36 relative to the drain cleaner 20. As shown, the drain cleaning cable 36 can be at least partially disposed in a guide hose 28 extending from a front region of the device. Typically, the electric power converter is configured to receive an alternating electrical current at its input and produce a direct electrical current at its output. The input of the converter is in electrical communication with the power receptacle 40. The power receptacle 40 as previously noted includes a recessed region 43 within which one or more electrical prongs 44 are accessible. And the output of the converter is in electrical communication with the motor. The motor is engaged with the drum 34 such that upon actuation of the motor, the drum 34 is rotated. In certain embodiments, the battery receiving region 46 includes provisions to releasably engage a battery such as the battery pack 50 to the drain cleaner tool 20. Such provisions can for example include one or more engagement members 48 that form a track for slidable engagement with the battery pack 50. Additional details and aspects of the drain cleaning tool 20 are described in one or more of US patents and/or U.S. published application Nos. U.S. 2016/0175899; U.S. 2008/0148503; U.S. Pat. No. 6,009,588; U.S. Pat. No. 7,367,077; U.S. 2008/0098544; U.S. Pat. No. 5,031,263; and U.S. Pat. No. 5,031,276.

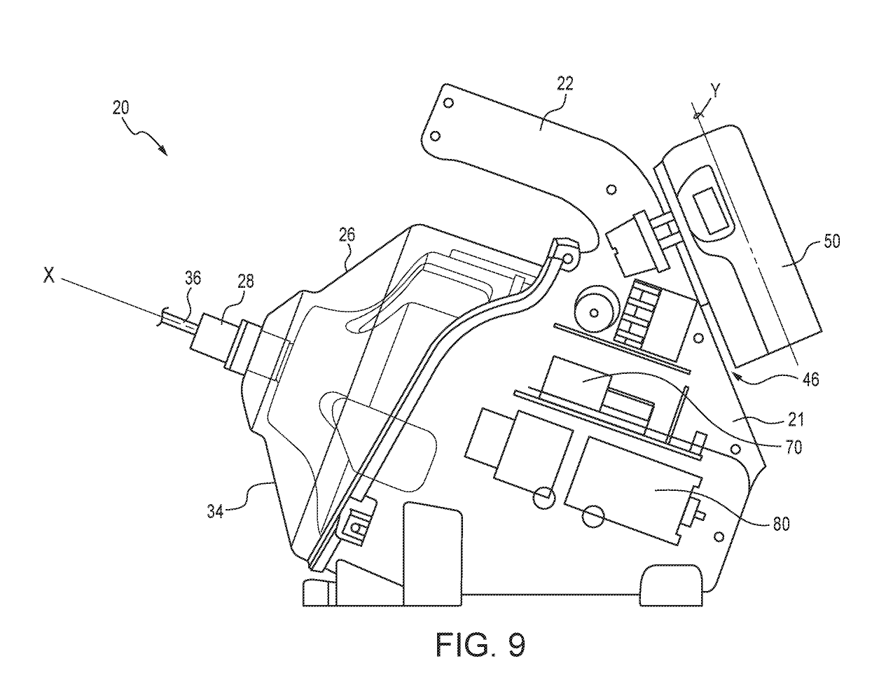

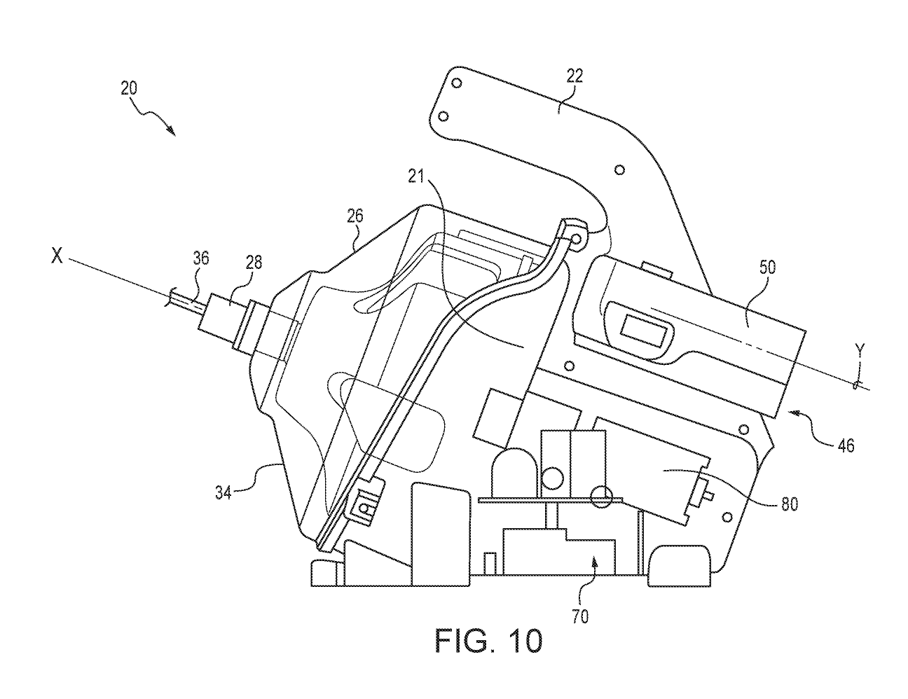

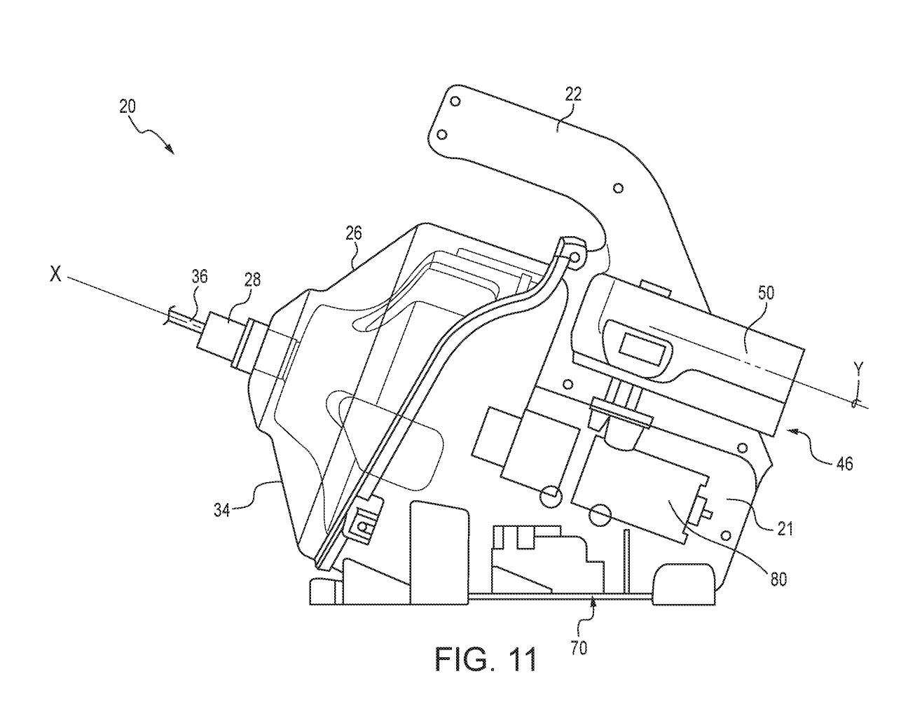

The drain cleaning tools of the present subject matter may utilize a variety of different arrangements and/or configurations for incorporating electronics and/or controls within the drain cleaner; manner of connection with a battery; and battery orientation. FIGS. 9-11 are schematic views of a hybrid power drain cleaner 20 illustrating various configurations for incorporating an electronics assembly 70 and a battery 50 with the drain cleaner 20. The hybrid power drain cleaner 20 includes a handle 22, a housing 21 that defines a generally hollow interior region within which are mounted the electronics assembly 70 and a motor 80. In the configuration shown in FIG. 9, the electronics assembly 70 is disposed within the housing 21 and located above the electric motor 80. In the configurations shown in FIGS. 10 and 11, the electronics assembly 70 is disposed within the housing 21 and located below or at least partially under the motor 80. The battery receiving region 46 is generally located along a rear portion of the housing 21. When the battery 50 is used to power the drain cleaner 20, the battery is selectively engaged with the battery receiving region 46 along an exterior of the housing 21, such that the battery 50 or its longitudinal axis Y, is inclined oriented at an acute angle relative to the axis of rotation X of the drain cleaning cable 36 immediately along the front of the tool. In the configuration shown in FIGS. 10 and 11, when the battery 50 is used to power the drain cleaner 20, the battery 50 is selectively engaged with the battery receiving region 46 along the exterior of the housing 21, such that the battery 50 or its longitudinal axis Y is oriented generally parallel with the axis X. This battery orientation along with the orientation depicted in FIG. 9 have been found to provide convenience and improved ergonomics for a user.

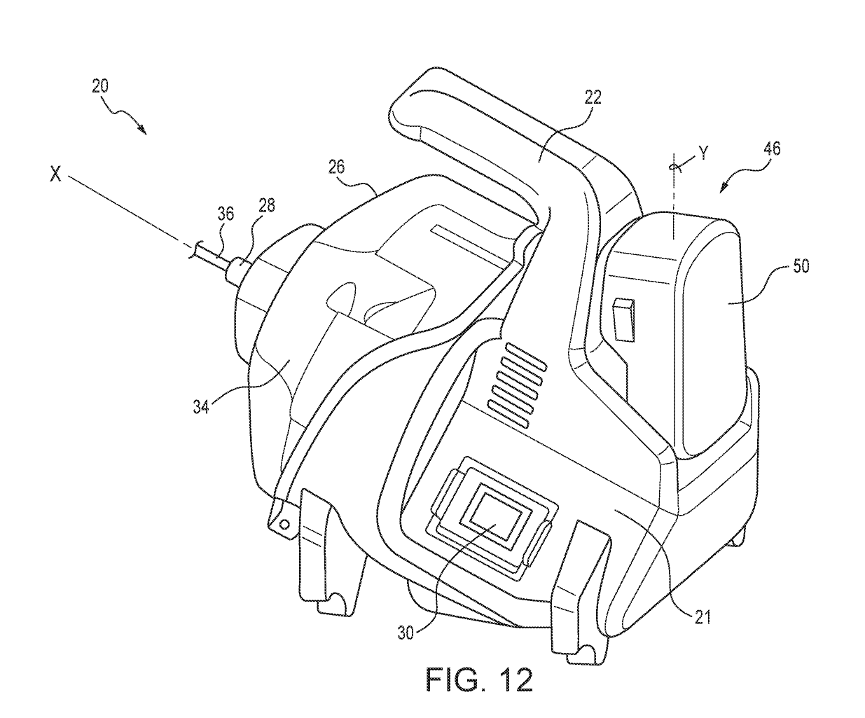

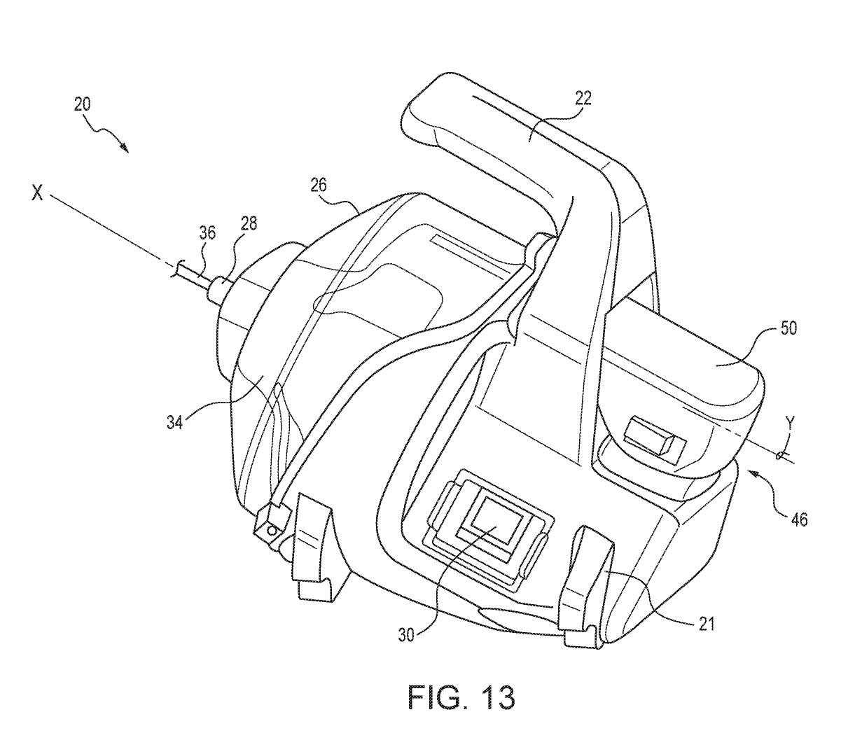

FIGS. 12 and 13 are schematic views of a hybrid power drain cleaner 20 illustrating additional configurations for incorporating a battery 50 with the drain cleaner 20. In the versions shown in FIG. 12, the battery 50 or its longitudinal axis Y is oriented transverse, or substantially so, to the axis X of rotation of the drain cleaning cable 36. In the version shown in FIG. 13, the battery 50 is selectively engaged with a battery receiving region 46 along an exterior of the housing 21, such that the battery 50 or its longitudinal axis Y is oriented generally parallel with the axis X.

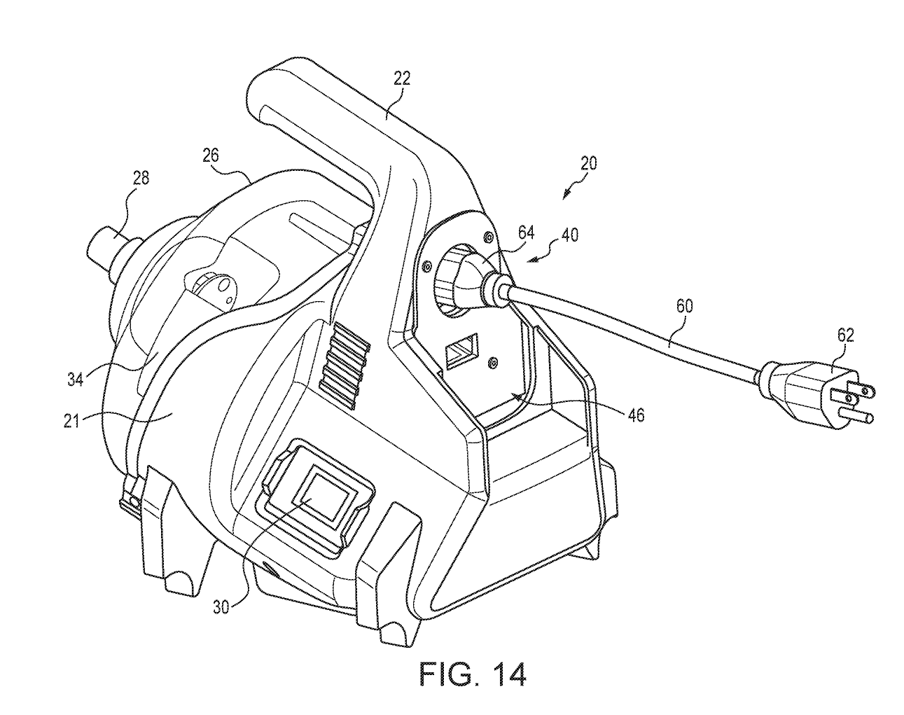

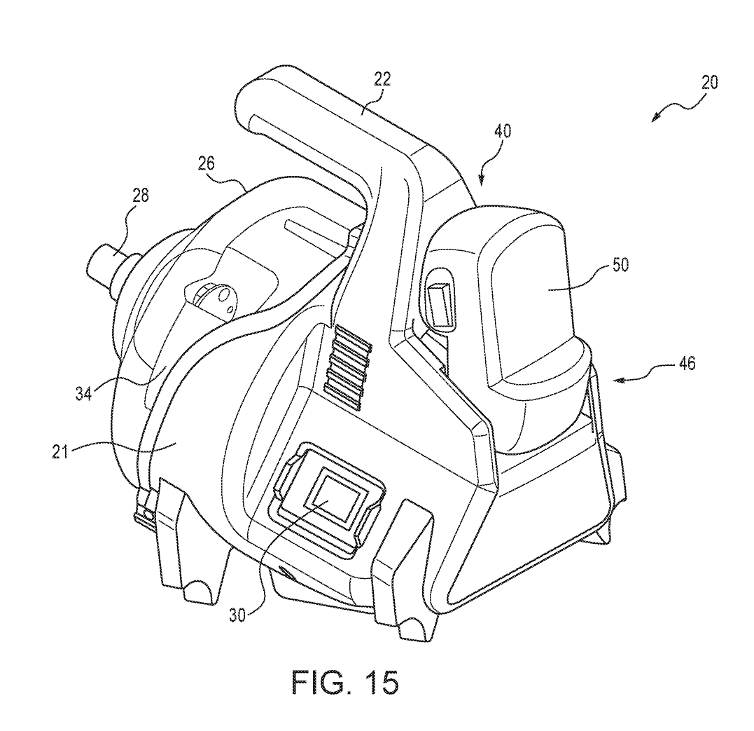

FIGS. 14 and 15 are schematic views of the hybrid power drain cleaner 20 of FIG. 12 in a corded configuration (FIG. 14) and in a battery configuration (FIG. 15). Specifically, FIG. 14 illustrates the drain cleaner 20 powered using a cord 60. One end 64 of the cord engages and is placed in electrical connection with the electrical power receptacle 40 provided along an outer region of the housing 21. As will be appreciated, the other end 62 of the cord 60 is connected to a source of electrical power such as for example an AC electrical outlet. In this corded configuration, access to a battery receiving region 46 is precluded due to the end 64 of the cord engaged with the receptacle 40 and thereby blocking access to the region 46. FIG. 15 illustrates the drain cleaner 20 powered using a battery 50. The battery 50 is engaged and electrically connected with the battery pack receiving region 46 located along an exterior region of the housing 21. In this battery configuration, access to the electrical power receptacle 40 is precluded. And in many versions, the electrical power receptacle 40 is blocked or otherwise protected against entry or contamination by water, dirt, and/or debris.

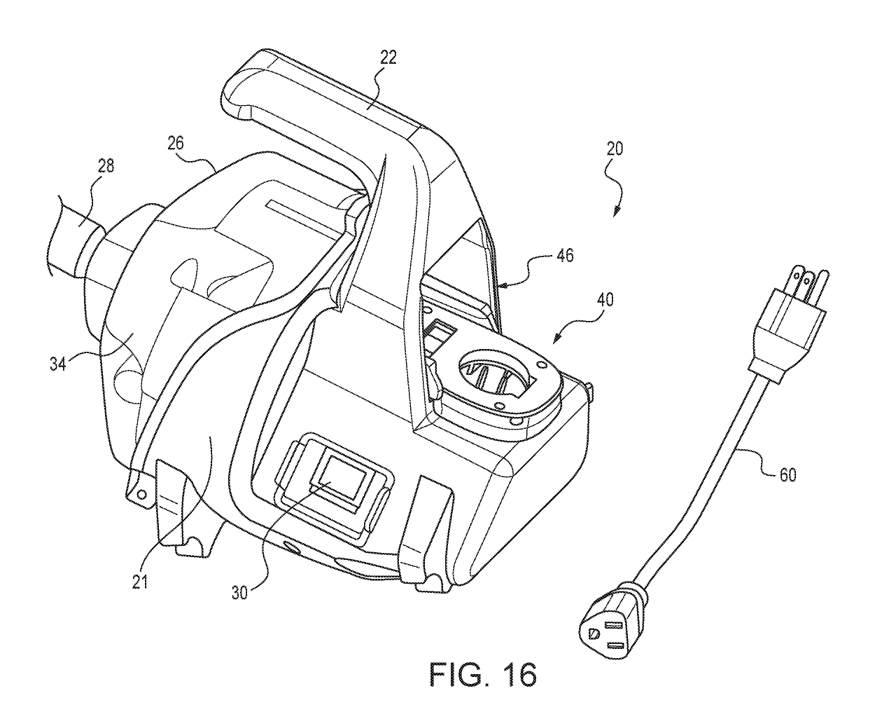

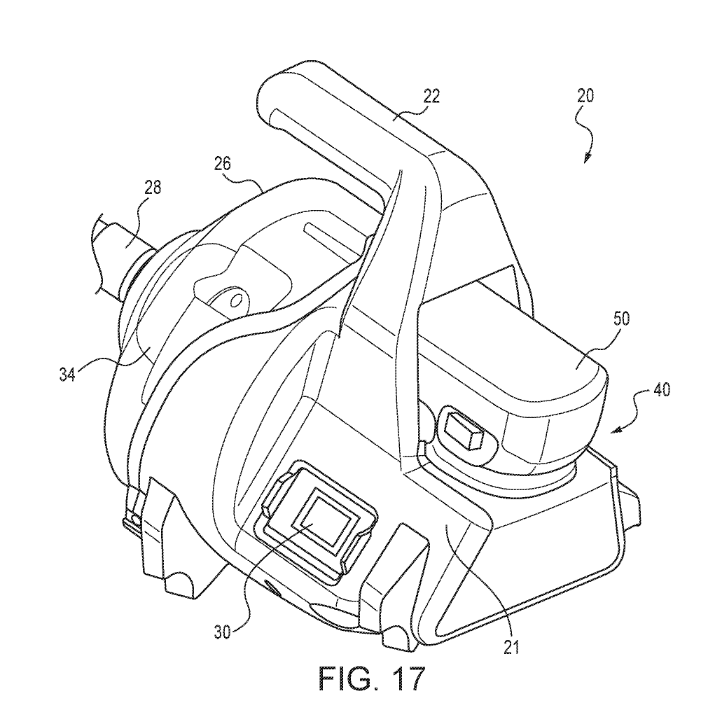

FIGS. 16 and 17 are schematic views of the hybrid power drain cleaner 20 of FIG. 13 in a corded configuration, prior to connection between the cord and the tool (FIG. 16) and in a battery configuration (FIG. 17). FIG. 16 illustrates an electric power receptacle 40, a battery receiving region 46, and a power cord 60. FIG. 17 illustrates the tool 20 with a battery 50 engaged thereto. When the battery 50 is connected to the battery receiving region 46, access to the electric power receptacle 40 is precluded. Also, in the battery configuration depicted in FIG. 17, the electrical power receptacle 40 is blocked or otherwise protected against entry or contamination by water, dirt, and/or debris.

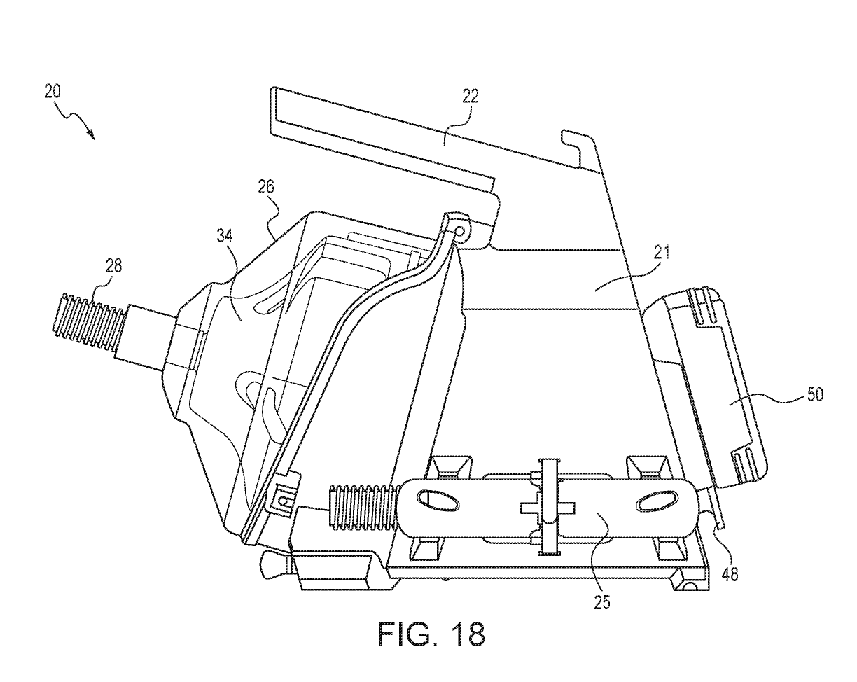

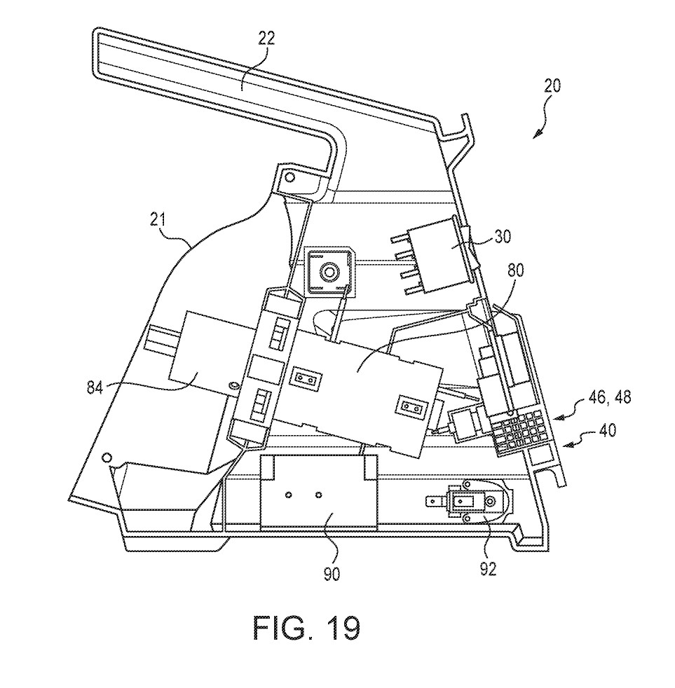

FIGS. 18 and 19 illustrate a hybrid power drain cleaner 20 and a representative configuration for various components mounted within an interior of the housing 21. As previously noted, the drain cleaner 20 generally includes a handle 22, and located along external region(s) of the housing 21, an electrical power receptacle 40 and a battery receiving region 46 which likely includes one or more outwardly projecting engagement members 48 that constitute a battery shoe as known in the art. The members 48 are sized and shaped to releasably engage a battery 50. As previously described, the electrical power receptacle 40 is configured to receive and/or engage a power cord such as previously described power cord 60 (not shown). The drain cleaner 20 additionally comprises an electric motor 80 and an optional gearbox or drive train 84 which transmits rotational motion of the motor shaft to a rotatable drum 34. The drain cleaner 20 may also optionally comprise a ground fault circuit interrupter (GFCI) and power converter assembly 90 disposed within the interior of the housing 21. The assembly 90 may include a rectifier. The drain cleaner 20 may also comprise a safety switch 92 or interlock which turns off or deactivates electrical power in the device upon detection of water in the housing. The drain cleaner 20 also includes one or more operating controls 30 such as an actuation switch governing operation of the drain cleaner 20. In certain versions, the tools or devices can include accessory engagement regions provided along exterior regions of the tool or device for releasably carrying or attaching one or more accessories 25.

The motor used in the tools and/or tool systems such as motor 80, is typically a DC motor. However, the present subject matter includes the use of other types of motors including universal motors. In particular embodiments, the motor is a DC motor and is a permanent magnet direct current (PMDC) or brushless DC motor.

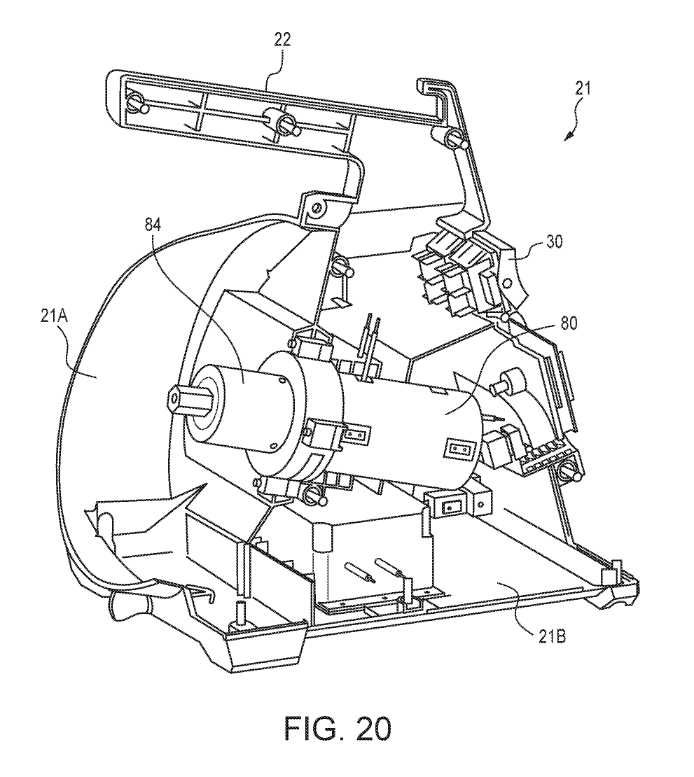

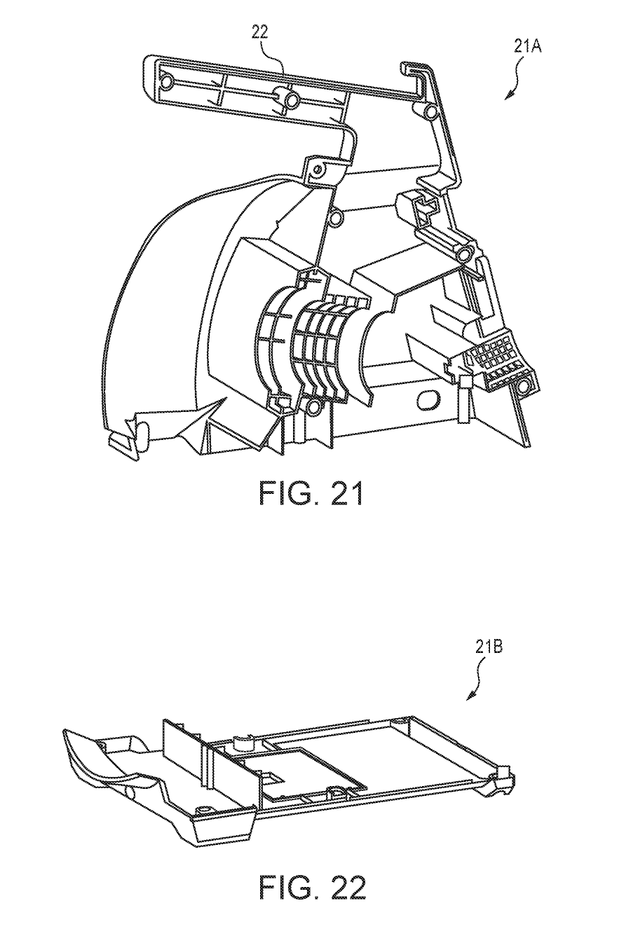

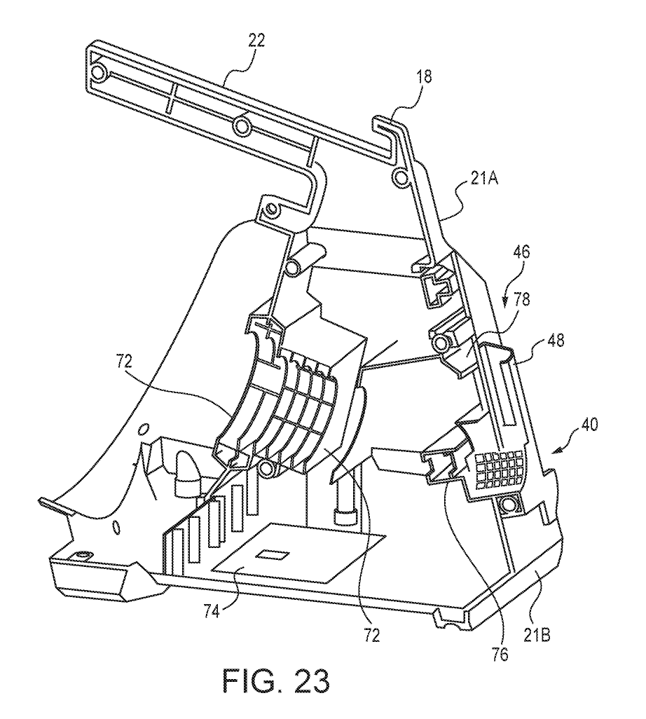

In certain versions of the drain cleaner 20, the housing 21 includes a plurality of housing components which facilitate assembly, manufacturing, and access to the interior of the housing 21. Referring to FIGS. 20-23, a first side housing component 21A is shown in FIG. 21, a bottom housing panel component 21B is shown in FIG. 22, and the assembly of housing components 21A and 21B is shown in FIG. 20. The housing 21 includes another side housing component (not shown) which corresponds to the component 21A but is configured to contact and engage the components 21A and 21B shown in FIG. 20, and thereby enclose the generally hollow interior defined therebetween. FIG. 20 also illustrates the motor 80, gearbox 84, and controls 30. FIG. 23 shows a similar version of the housing components 21A and 21B in isolation, free of any components disposed or mounted therein. In the particular embodiment depicted in FIGS. 20-23, the housing 21 consists of a total of three (3) housing components which when assembled together, form the housing 21 and provide an enclosed hollow interior for mounting the various components of the tool or device. FIG. 23 additionally illustrates motor mounts 72 which can be in the form of projection(s) having arcuate edges that contact and support the motor 80. A mount 74 for a GFCI or other electrical or power converter component may be provided. The housing 21 also includes a plug mount 76 for supporting or accessing the power receptacle 40. One or more cable wraps 18 may be provided along exterior region(s) of the housing 21. The battery receiving region typically includes one or more outwardly projecting members 48 that constitute or otherwise form a track or slide for slidable engagement with a battery 50. The housing 21 may also include a battery catch or latch 78 for releasable securement of a battery to the housing 21.

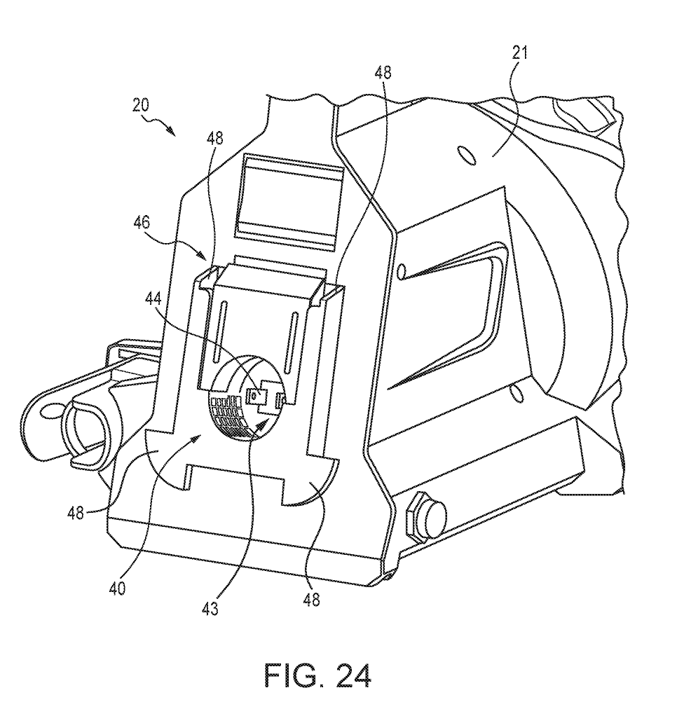

FIG. 24 is a partial rear perspective view of a hybrid power drain cleaner 20 illustrating a configuration in which an electrical power receptacle 40 is accessible along a rear face or region of the device. FIG. 24 also shows a battery receiving region 46 also disposed along a rear face or region of the device.

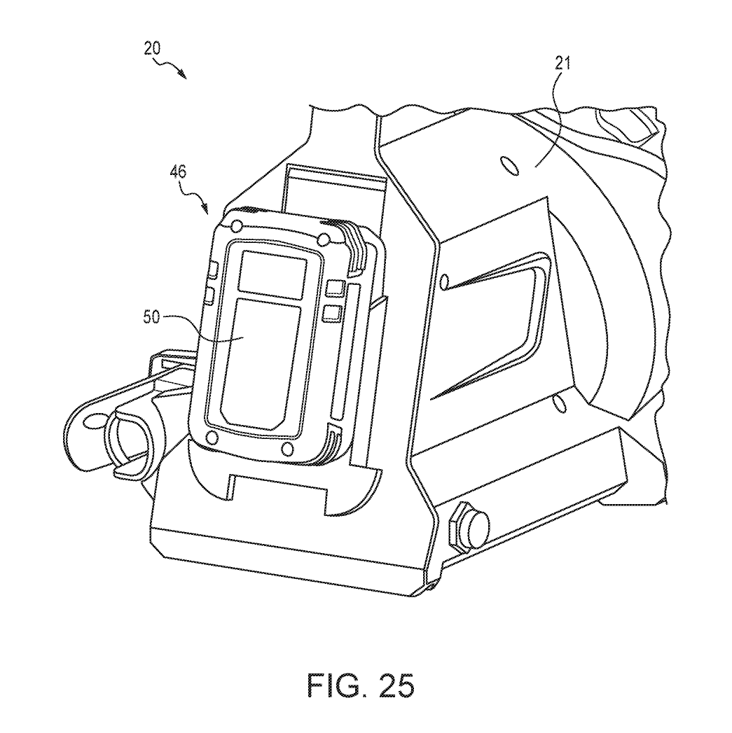

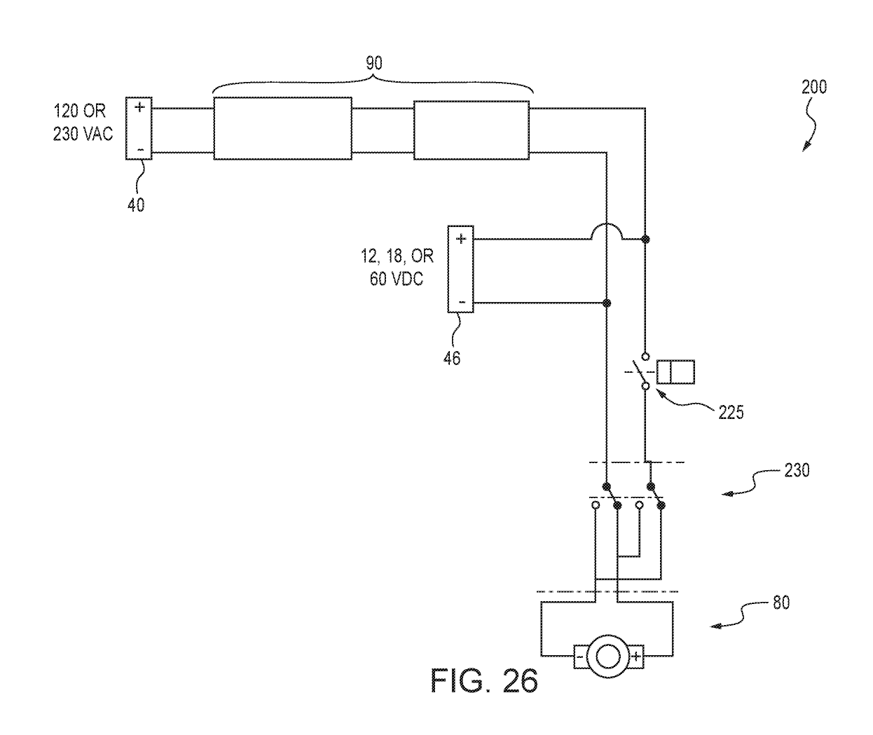

FIG. 25 is a partial rear perspective view of the hybrid power drain cleaner 20 shown in FIG. 24, illustrating a configuration in which the electrical power receptacle 40 is not accessible because the receptacle is blocked or otherwise covered by a battery 50 which is engaged at a battery receiving region 46.

FIG. 26 is a schematic diagram illustrating another power circuit 200 used in an embodiment of a hybrid power drain cleaner. The power circuit 200 includes a GFCI/power converter assembly 90 which is in electrical communication with the electrical power receptacle 40. The power circuit 200 is also in electrical communication with the battery receiving region 46. The circuit 200 provides electrical communication to an input 230 or like component for powering the motor 80. The circuit 200 may also include one or more switches such as a momentary contact switch 225. As previously described, the electrical power receptacle 40 receives AC power, and typically at 120 volts or 230 volts. The assembly 90 transforms the AC power to DC power and typically to a lower voltage. The battery receiving region 46 receives DC power and typically at 12 volts, 18 volts, or 60 volts. In this version of the circuit 200, electrical communication of a battery, i.e., via the battery receiving region 46, is provided at a location between the output of the power converter assembly 90 and the motor 80.

It is also contemplated that the tool or drain cleaner can be configured such that when powered from an external AC power source and the battery is stored on the tool or drain cleaner, the battery can also be receiving a charge from the power source to replenish or recharge the battery.

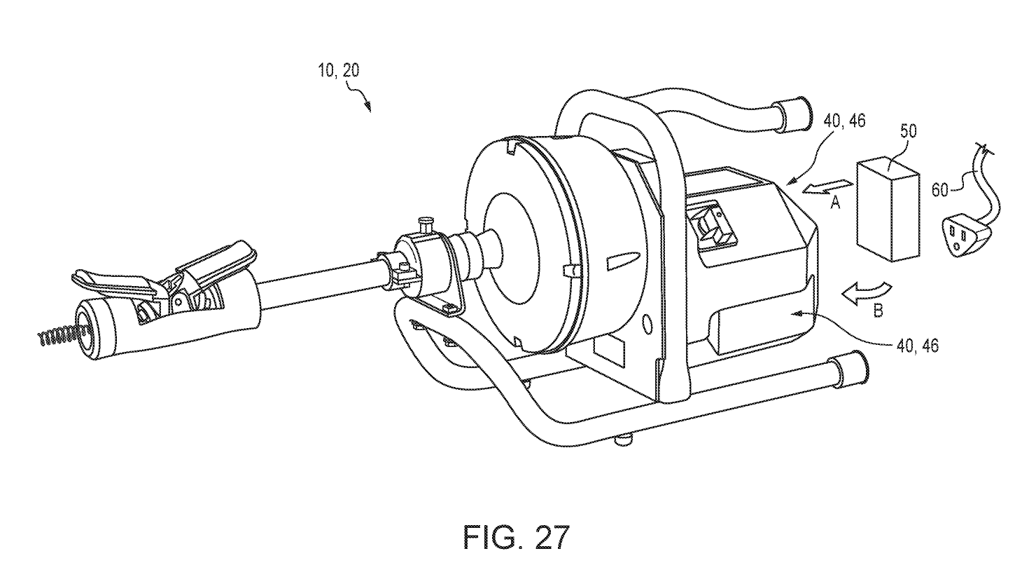

It will be understood that the present subject matter can be incorporated in a wide array of other types and/or configurations of drain cleaning devices. For example, FIG. 27 illustrates a system 10 comprising a hybrid power drain cleaner 20 having a power receiving assembly with an electric power receptacle 40 and a battery receiving region 46 for electrical communication with a separable battery 50 and/or a power cord 60. FIG. 27 shows that the power receptacle 40 and battery receiving region 46 can be provided at different locations such as A or B along the housing of the drain cleaner 20.

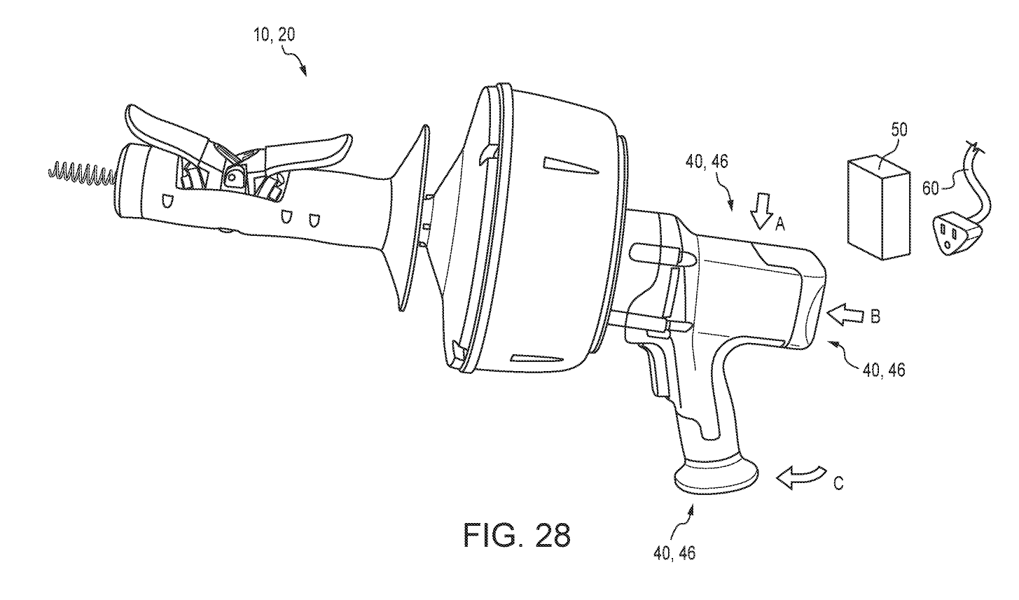

FIG. 28 illustrates another system 10 comprising a hybrid power drain cleaner 20 having a power receiving assembly with an electric power receptacle 40 and a battery receiving region 46 for electrical communication with a separable battery 50 and/or a power cord 60. FIG. 28 illustrates that the power receptacle 40 and battery receiving region 46 can be provided at different locations such as A, B, or C along the housing of the drain cleaner 20.

The present subject matter also provides a hybrid power drain cleaning device or other type of tool comprising a housing defining an internal hollow region, and a converter having an input and an output. The converter is configured to receive an alternating electrical current at the input and produce a direct electrical current at the output. The converter is disposed and mounted within the internal region of the housing. The device also comprises a rotatable drum, and an electric motor disposed and mounted within the internal region of the housing. The electric motor is in electrical communication with the output of the converter, Upon actuation of the electric motor, the rotatable drum is rotated. The device also comprises a power cord receptacle accessible for engagement with a power cord along an exterior of the housing. The power cord receptacle is in electrical communication with the input of the converter. The device additionally comprises a battery receiving region accessible along an exterior of the housing. The battery receiving region includes provisions to releasably engage a battery o the device. The device further comprises a rotatable drain cleaning cable at least partially disposed in the drum, and provisions for extending and retracting the drain cleaning cable relative to the device.

The present subject matter can be implemented in nearly any electrically powered tool or tool system. For example, the tool can be in the form of a drain cleaning device, as described herein. Alternatively, for example, the tool could also be in the form of a powered threader device used to form pipe threads on a workpiece, Furthermore, for example the tool could be in the form of a pipe cutting device. In addition, the tool could be in the form of a powered saw or saw devices such as a circle saw. Still another example is a beveller device used to bevel or otherwise form a shaped edge or end of a workpiece. Another example of a tool is a fetter device used to remove debris or dirt or unwanted material from a substrate or region of interest. Still another example is a vacuum collection device which collects debris, dirt, or other material. Tools and/or tool systems using these devices in combination with other tools or tool systems are also contemplated.

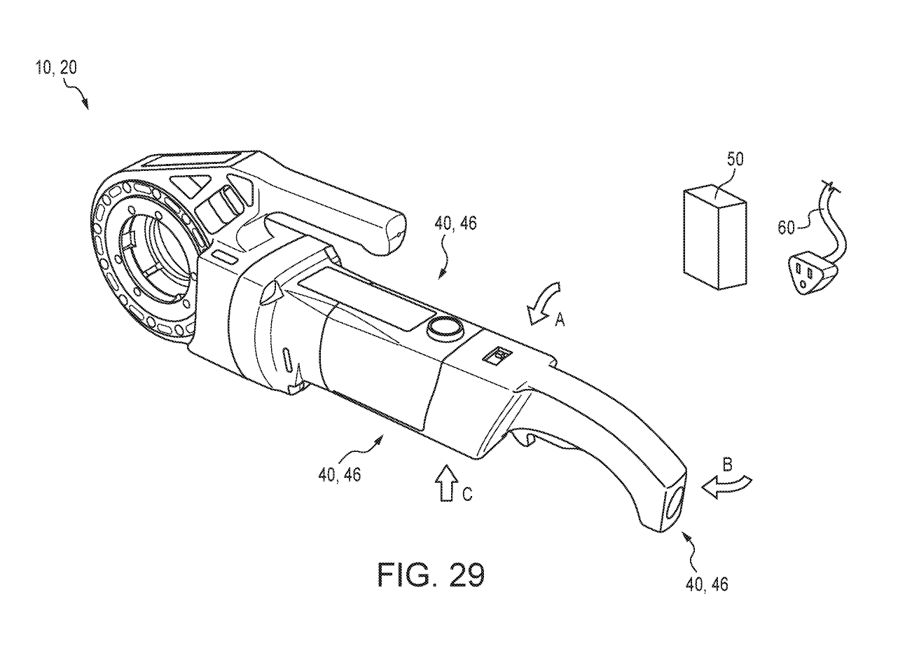

FIG. 29 illustrates a system 10 comprising a hybrid power tool 20 in the form of a powered threader device having a power receiving assembly with an electric power receptacle 40 and a battery receiving region 46 for electrical communication with a separable battery 50 and/or a power cord 60. FIG. 29 shows that the power receptacle 40 and the battery receiving region 46 can be provided at different locations such as A, B, or C along the housing of the powered threader device. The powered threader device also includes a rotatable drive for rotating a thread cutting assembly. A wide array of thread cutting assemblies are known, many of which include one or more cutting dies.

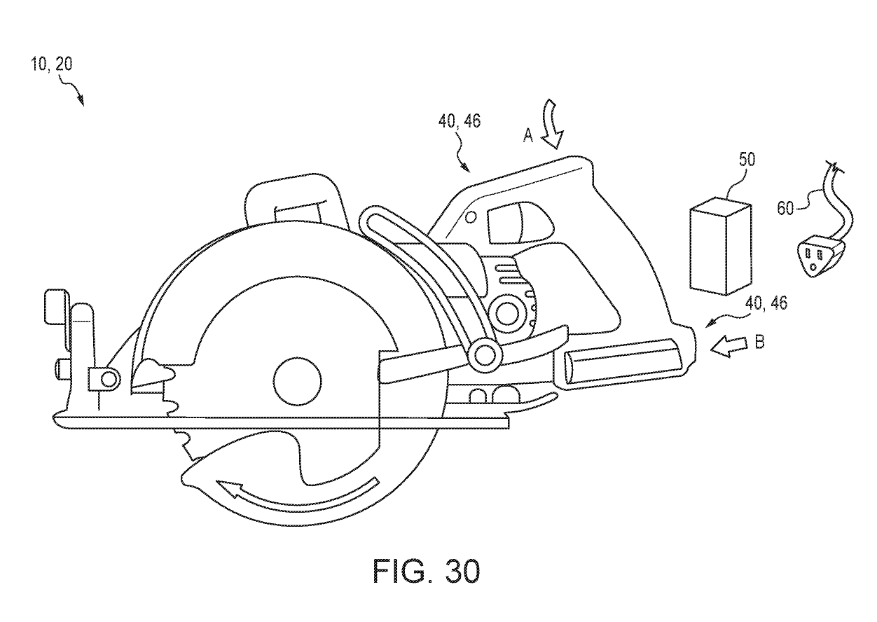

FIG. 30 illustrates a system 10 comprising a hybrid power tool 20 in the form of a saw, and more particularly a circle saw, having a power receiving assembly with an electric power receptacle 40 and a battery receiving region 46 for electrical communication with a separable battery 50 and/or a power cord 60. FIG. 30 illustrates that the power receptacle 40 and the battery receiving region 46 can be provided at different locations such as for example A or B along the housing of the saw. The saw also includes a rotatable drive for displacing a cutting blade. Although in many versions the blade is rotatably displaced, the present subject matter includes assemblies in which the blade is linearly displaced in a reciprocating manner.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features. In addition, it will be understood that details of aspects of the present subject matter provided in association with one type of tool may be applicable to another type of tool. Thus, description of the present subject matter in various drain cleaners shall be understood to also apply with regard to other tools and tool types.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. An electrically powered device comprising:
a housing defining an internal hollow region;
an electrical power converter having an input and an output, the converter configured to receive an alternating electrical current at the input and produce a direct electrical current at the output, the converter disposed and mounted within the internal region of the housing;
an electric motor disposed and mounted within the internal region of the housing, the electric motor in electrical communication with the output of the converter;
a power cord receptacle accessible for engagement with a power cord along an exterior of the housing, the power cord receptacle in electrical communication with the input of the converter;
a battery receiving region accessible along an exterior of the housing, the battery receiving region including provisions to releasably engage a battery to the device.

2. The device of claim 1 wherein the power cord receptacle includes (i) a recessed region along an exterior face of the housing, and (ii) a plurality of outwardly projecting electrical prongs disposed in the recessed region.

3. The device of claim 1 wherein the battery receiving region includes at least one electrical terminal for electrical connection with a corresponding terminal of a separable battery and at least one of (i) a latch for selective coupling with the separable battery and (ii) a track for selective sliding engagement with the separable battery.

4. The device of claim 1 wherein the electric motor is a direct current motor.

5. The device of claim 1 wherein the device is selected from the group of drain cleaning devices, threader devices, pipe cutting devices, saw devices, beveller devices, fetter devices, vacuum collection devices, and combinations thereof.

6. The device of claim 1 wherein the device is a drain cleaning device and further comprises:
a rotatable drain cleaning cable;
provisions for extending and retracting the drain cleaning cable relative to the device.

7. The device of claim 1 further comprising:
a battery configured for engagement with the battery receiving region of the device.

8. The device of claim 1 wherein upon placement of a battery in the battery receiving region and engagement of the battery to the device, access to the power cord receptacle from the exterior of the device is precluded.

9. The device of claim 1 wherein upon the battery receiving region being free of a battery placed therein, the power cord receptacle is accessible from the exterior of the device for engagement with a power cord.

10. The device of claim 1 wherein upon engagement and placement of a power cord in the power cord receptacle of the device, electrical connection of a battery in the battery receiving region of the device is precluded.

11. The device of claim 1 wherein the electrical power converter receives the electrical current at the input and provides the electrical current at the output such that a voltage of the electrical current at the output is less than a voltage of the electrical current at the input.

12. The device of claim 11 wherein the voltage of the electrical current at the input is within a range of 100 volts to 250 volts.

13. The device of claim 11 wherein the voltage of the electrical current at he output is within a range of from 6 to 60 volts.

14. An electrically powered device comprising:
a housing defining an internal hollow region;
an electric motor disposed and mounted within the internal region of the housing;
a power cord receptacle selectively accessible for engagement with a power cord along an exterior of the housing;
a battery receiving region accessible along an exterior of the housing, the battery receiving region including provisions to releasably engage a battery to the device;
wherein upon placement of a battery in the battery receiving region and engagement of the battery to the device, access to the power cord receptacle from the exterior of the device is precluded.

15. The device of claim 14 wherein upon the battery receiving region being free of a battery placed therein, the power cord receptacle is accessible from the exterior of the device for engagement with a power cord.

16. The device of claim 14 wherein upon engagement and placement of a power cord in the power cord receptacle of the device, electrical connection of a battery in the battery receiving region of the device is precluded.

17. The device of claim 14 wherein the power cord receptacle includes (i) a recessed region along an exterior face of the housing, and (ii) a plurality of outwardly projecting electrical prongs disposed in the recessed region.

18. The device of claim 14 wherein the battery receiving region includes at least one electrical terminal for electrical connection with a corresponding terminal of a separable battery and at least one of (i) a latch for selective coupling with the separable battery and (ii) a track for selective sliding engagement with the separable battery.

19. The device of claim 14 wherein the electric motor is a direct current motor.

20. The device of claim 14 wherein the device is selected from the group of drain cleaning devices, threader devices, pipe cutting devices, saw devices, beveller devices, fetter devices, vacuum collection devices, and combinations thereof.

21. The device of claim 14 wherein the device is a drain cleaning device and further comprises:
a rotatable drain cleaning cable;
provisions for extending and retracting the cable relative to the device.

22. The device of claim 14 further comprising:
a battery configured for engagement with the battery receiving region of the device.

23. The device of claim 14 further comprising:
an electrical power converter disposed and mounted within the internal region of the housing, the converter having an input and an output, the converter configured to receive an alternating electrical current at the input and produce a direct electrical current at the output.

24. The device of claim 23 wherein the electrical power converter receives the electrical current at the input and provides the electrical current at the output such that a voltage of the electrical current at the output is less than a voltage of the electrical current at the input.

25. The device of claim 24 wherein the voltage of the electrical current at the input is within a range of 100 volts to 250 volts.

26. The device of claim 25 wherein the voltage of the electrical current at the output is within a range of from 6 to 60 volts.

27. A drain cleaning device comprising:
a housing defining an internal hollow region;
a rotatable drum;
an electric motor disposed and mounted within the internal region of the housing, wherein upon actuation of the electric motor, the rotatable drum is rotated;
a rotatable drain cleaning cable, at least partially disposed in the drum;
provisions for extending and retracting the drain cleaning cable relative to the device;
a power cord receptacle selectively accessible for engagement with a power cord along an exterior of the housing;
a battery receiving region accessible along an exterior of the housing, the battery receiving region including provisions to releasably engage a battery to the device;
wherein upon placement of a battery in the battery receiving region and engagement of the battery to the device, access to the power cord receptacle from the exterior of the device is precluded.

28. The drain cleaning device of claim 27 wherein upon the battery receiving region being free of a battery placed therein, the power cord receptacle is accessible from the exterior of the device for engagement with a power cord.

29. The drain cleaning device of claim 27 wherein upon engagement and placement of a power cord in the power cord receptacle of the device, electrical connection of a battery in the battery receiving region of the device is precluded.

30. The drain cleaning device of claim 27 wherein the power cord receptacle includes (i) a recessed region along an exterior face of the housing, and (ii) a plurality of outwardly projecting electrical prongs disposed in the recessed region.

31. The drain cleaning device of claim 27 wherein the battery receiving region includes at least one electrical terminal for electrical connection with a corresponding terminal of a separable battery and at least one of (i) a latch for selective coupling with the separable battery and (ii) a track for selective sliding engagement with the separable battery.

32. The drain cleaning device of claim 27 wherein the electric motor is a direct current motor.

33. The drain cleaning device of claim 27 further comprising:
a battery configured for engagement with the battery receiving region of the device. 34, The drain cleaning device of claim 27 further comprising:
a converter disposed and mounted within the internal region of the housing, the converter having an input and an output, the converter configured to receive an alternating electrical current at the input and produce a direct electrical current at the output.

35. The drain cleaning device of claim 27 wherein the electrical power converter receives the electrical current at the input and provides the electrical current at the output such that a voltage of the electrical current at the output is less than a voltage of the electrical current at the input.

36. The drain cleaning device of claim 35 wherein the voltage of the electrical current at the input is within a range of 100 volts to 250 volts.

37. The drain cleaning device of claim 35 wherein the voltage of the electrical current at the output is within a range of from 6 to 60 volts.

38. A powered threader device comprising:
a housing defining an internal hollow region;
a rotatable drive for rotating a thread cutting assembly;
an electric motor disposed and mounted within the internal region of the housing, wherein upon actuation of the electric motor, the thread cutting assembly is rotated;
a power cord receptacle selectively accessible for engagement with a power cord along an exterior of the housing;
a battery receiving region accessible along an exterior of the housing, the battery receiving region including provisions to releasably engage a battery o the device;
wherein upon placement of a battery in the battery receiving region and engagement of the battery to the device, access to the power cord receptacle from the exterior of the device is precluded.

39. The powered threader device of claim 38 wherein upon the battery receiving region being free of a battery placed therein, the power cord receptacle is accessible from the exterior of the device for engagement with a power cord.

40. The powered threader device of claim 38 wherein upon engagement and placement of a power cord in the power cord receptacle of the device, electrical connection of a battery in the battery receiving region of the device is precluded.

41. The powered threader device of claim 38 wherein the power cord receptacle includes (i) a recessed region along an exterior face of the housing, and (ii) a plurality of outwardly projecting electrical prongs disposed in the recessed region.

42. The powered threader device of claim 38 wherein the battery receiving region includes at least one electrical terminal for electrical connection with a corresponding terminal of a separable battery and at least one of (i) a latch for selective coupling with the separable battery and (ii) a track for selective sliding engagement with the separable battery.

43. The powered threader device of claim 38 wherein the electric motor is a direct current motor.

44. The powered threader device of claim 38 further comprising:
a battery configured for engagement with the battery receiving region of the device.

45. The powered threader device of claim 38 further comprising:
a converter disposed and mounted within the internal region of the housing, the converter having an input and an output, the converter configured to receive an alternating electrical current at the input and produce a direct electrical current at the output.

46. The powered threader device of claim 38 wherein the electrical power converter receives the electrical current at the input and provides the electrical current at the output such that a voltage of the electrical current at the output is less than a voltage of the electrical current at the input.

47. The powered threader device of claim 46 wherein the voltage of the electrical current at the input is within a range of 100 volts to 250 volts.

48. The powered threader device of claim 46 wherein the voltage of the electrical current at the output is within a range of from 6 to 60 volts.

49. A powered saw device comprising:
a housing defining an internal hollow region;
a rotatable drive for displacing a cutting blade;
an electric motor disposed and mounted within the internal region of the housing, wherein upon actuation of the electric motor, the cutting blade is displaced;
a power cord receptacle selectively accessible for engagement with a power cord along an exterior of the housing;
a battery receiving region accessible along an exterior of the housing, the battery receiving region including provisions to releasably engage a battery to the device;
wherein upon placement of a battery in the battery receiving region and engagement of the battery to the device, access to the power cord receptacle from the exterior of the device is precluded.

50. The powered saw device of claim 49 wherein upon the battery receiving region being free of a battery placed therein, the power cord receptacle is accessible from the exterior of the device for engagement with a power cord.

51. The powered saw device of claim 49 wherein upon engagement and placement of a power cord in the power cord receptacle of the device, electrical connection of a battery in the battery receiving region of the device is precluded.

52. The powered saw device of claim 49 wherein the power cord receptacle includes (i) a recessed region along an exterior face of the housing, and (ii) a plurality of outwardly projecting electrical prongs disposed in the recessed region.

53. The powered saw device of claim 49 wherein the battery receiving region includes at least one electrical terminal for electrical connection with a corresponding terminal of a separable battery and at least one of (i) a latch for selective coupling with the separable battery and (ii) a track for selective sliding engagement with the separable battery.

54. The powered saw device of claim 49 wherein the electric motor is a direct current motor.

55. The powered saw device of claim 49 further comprising:
a battery configured for engagement with the battery receiving region of the device.

56. The powered saw device of claim 49 further comprising:
a converter disposed and mounted within the internal region of the housing, the converter having an input and an output, the converter configured to receive an alternating electrical current at the input and produce a direct electrical current at the output.

57. The powered saw device of claim 49 wherein the electrical power converter receives the electrical current at the input and provides the electrical current at the output such that a voltage of the electrical current at the output is less than a voltage of the electrical current at the input.

58. The powered saw device of claim 57 wherein the voltage of the electrical current at the input is within a range of 100 volts to 250 volts.

59. The powered saw device of claim 57 wherein the voltage of the electrical current at the output is within a range of from 6 to 60 volts.
